(19) United States
(12) Patent Application Publication
(10) Pub. No.: US 2024/0109251 A1
(43) Pub. Date: Apr. 4, 2024

(54) IRRADIATION SYSTEMS AND METHOD FOR ADDITIVE MANUFACTURING

(71) Applicant: Struto Pte Ltd., Singapore (SG)

(72) Inventors: Ahmed Shamir Yusuf, Mississuga (CA); Hubertus Theodorus Petrus Van Esbroeck, Mississauga (CA)

(21) Appl. No.: 17/768,549

(22) PCT Filed: Oct. 13, 2020
(86) PCT No.: PCT/SG2020/050585

§ 371 Date: Apr. 13, 2022

(30) Foreign Application Priority Data
Oct. 14, 2019 (SG) 10201909593U

(51) Int. Cl. B29C 64/282; B29C 64/129; B29C 64/245; B29C 64/291; B33Y 10/00; B33Y 30/00

(52) U.S. Cl. CPC B29C 64/282; B29C 64/129; B29C 64/245; B29C 64/291; B33Y 10/00; B33Y 30/00

(57) ABSTRACT

Additive manufacturing devices and systems are provided. An additive manufacturing device comprises a vessel containing a material which is polymerisable on exposure to radiation, and a programmable radiation module comprising an array of individually addressable radiation emitting elements. The programmable radiation module is positionable for an irradiation surface of the programmable radiation module to be in direct contact with the material, the array is programmable to produce radiation having a pattern by selective activation of the elements of the array, and the programmable radiation module is positionable to irradiate the material adjacent the irradiation surface. The additive manufacturing device further comprises a build platform having a build surface, the build platform being configured for movement relative to the irradiation surface. Also provided is an additive manufacturing method which employs the additive manufacturing device.

### CROSS-REFERENCE TO A RELATED APPLICATION

This application claims priority from Singapore Patent Application No. 10201909593U, the contents of which are incorporated herein by reference in its entirety.

### FIELD

The present specification relates to additive manufacturing methods and systems and, in particular, to a stereolithographic additive manufacturing device comprising radiation emitting elements.

### BACKGROUND

Additive manufacturing is the process of forming three dimensional objects by adding material, effectively building up an object, as opposed to traditional subtractive methods such as carving or computer numerical control (CNC) machining, in which a three dimensional object is formed by removing material from a larger piece. Generally, in most apparatuses and methods for additive manufacturing, the three-dimensional object is built up layer by layer in a vertical direction. The desired three-dimensional object is formed out of a stack of very thin layers of material, each such layer being the representation of the object's cross-section at the vertical position of that layer within the object.

### SUMMARY

According to an implementation of the present specification there is provided an additive manufacturing device. The additive manufacturing device comprises a vessel containing a material which is polymerisable on exposure to radiation; a programmable radiation module comprising an array of individually addressable radiation emitting elements, wherein: the programmable radiation module is positionable for an irradiation surface of the programmable radiation module to be in direct contact with the material; the array is programmable to produce radiation having a pattern by selective activation of the elements of the array, and the programmable radiation module is positionable to irradiate the material adjacent the irradiation surface; and a build platform having a build surface, the build platform being configured for movement relative to the irradiation surface.

The plurality of radiation emitting elements may comprise a plurality of micro light emitting diodes (LEDs) on a substrate.

The micro LEDs may be configured to emit monochromatic light.

The array may comprise a plurality of tessellated members, and wherein each tessellated member comprises a plurality of radiation emitting elements.

The array may comprise gaps between the plurality of tessellated members for a gas to permeate through the irradiation surface.

The array may be encapsulated in a transparent material that forms an encapsulant layer at a face of the programmable radiation module, and wherein the encapsulant layer forms the irradiation surface.

The substrate and the encapsulant layer may be permeable to a gas.

The array may be encapsulated in a transparent material that forms an encapsulant layer at a face of the programmable radiation module, and wherein the encapsulant layer forms the irradiation surface.

The substrate may be non-permeable to a gas, and the encapsulant layer may be permeable to the gas.

The programmable radiation module may comprise a non-stick film that forms the irradiation surface.

The additive manufacturing device may further comprise an optical assembly configured to modify the radiation generated by the array of individually addressable radiation emitting elements.

Each of the plurality of tessellated members may be individually encapsulated by a transparent material.

The substrate, and the individually encapsulated tessellated members of the array may be permeable to a gas.

According to another implementation of the present specification there is provided an additive manufacturing method, comprising: at least partially filling a vessel with a material which is polymerisable on exposure to radiation; providing a programmable radiation module having an irradiation surface, the programmable radiation module comprising an array of individually addressable radiation emitting elements; providing a build platform having a build surface; positioning the programmable radiation module for the irradiation surface of the programmable radiation module to be in direct contact with the material; positioning the build platform relative to the irradiation surface such that a layer of uncured material is defined between the build surface and the irradiation surface; and irradiating the layer of uncured material with radiation, wherein irradiating comprises selectively activating the radiation emitting elements of the array of the programmable radiation module to polymerise the layer of uncured material by the radiation having a pattern generated by the selectively activated radiation emitting elements.

### BRIEF DESCRIPTION OF THE DRAWINGS

It will be convenient to further describe the present disclosure with respect to the accompanying drawings that illustrate possible arrangements of the disclosure. Other arrangements of the disclosure are possible and consequently, the particularity of the accompanying drawings is not to be understood as superseding the generality of the preceding description of the disclosure.

Also, in the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the shapes of the elements as drawn are not necessarily intended to convey any information regarding the actual shape of the particular elements, and have been solely selected for ease of recognition in the drawings.

FIG. 1A illustrates an exploded schematic view of an example additive manufacturing device according to some implementations of the present specification;

FIG. 1B illustrates a schematic view of the example additive manufacturing device of FIG. 1A;

FIG. 1C illustrates a front cross-sectional view of the example additive manufacturing device of FIG. 1A;

FIG. 1D illustrates an exploded view of a section of the example additive manufacturing device of FIG. 1A;

FIG. 2 illustrates an example micro light emitting diode (LED) array of an additive manufacturing device according to some implementations of the present specification;

FIG. 3A and FIG. 3B illustrate positioning of an example programmable radiation module comprising a micro LED array in an example additive manufacturing device according to some implementations of the present specification;

FIG. 4A, FIG. 4B, and FIG. 4C illustrate different example emitter arrangements of an example micro LED array according to some implementations of the present specification;

FIG. 5A and FIG. 5B illustrate a tessellated structure of an example micro LED array according to some implementations of the present specification;

FIG. 6A illustrates a three-dimensional view of an example micro LED array comprising tessellated members according to some implementations of the present specification;

FIG. 6B illustrates a cross-sectional view of the example micro-LED array of FIG. 6A;

FIGS. 7A and 7B illustrate gas diffusion through an example porous micro LED array according to some implementations of the present specification;

FIGS. 8A, 8B, 8C, and 8D illustrate pores placement in an example micro LED array according to some implementations of the present specification;

FIGS. 9A and 9B illustrate a three-dimensional and a cross-sectional view respectively of a section of an example additive manufacturing device employing an example porous micro LED array according to some implementation of the present specification;

FIG. 10A, FIG. 10B, FIG. 10C, FIG. 10D, and FIG. 10E illustrate gas diffusion through different variations of an example micro LED array according to some implementations of the present specification; and

FIG. 11 illustrates a flow diagram of an example additive manufacturing method according to some implementations of the present specification.

### DETAILED DESCRIPTION

Existing additive manufacturing systems suffer from various drawbacks such as, but not limited to, slow printing rates, low print resolution, inefficiency etc. For example, many stereolithography (SLA) based additive manufacturing devices have slow printing rates. Digital Light Processing (DLP) based additive manufacturing devices are faster than the SLA based devices, however they are not scalable as the pixel size gets too large in these devices, it results in low resolution when projected over a larger print area. Some additive manufacturing devices enable rapid printing and scalability using Liquid Crystal Display (LCD), however they are inefficient in terms of energy usage since most of the energy input is lost as heat to the LCD. Furthermore, the LCD based additive manufacturing devices suffer from limitations in terms of wavelengths that can pass through the LCD as some novel resin materials in a three-dimensional (3D) printing market require lower wavelengths to cure which is not possible in such devices.

The present disclosure seeks to overcome one or more of the above disadvantages, or at least to provide a useful alternative.

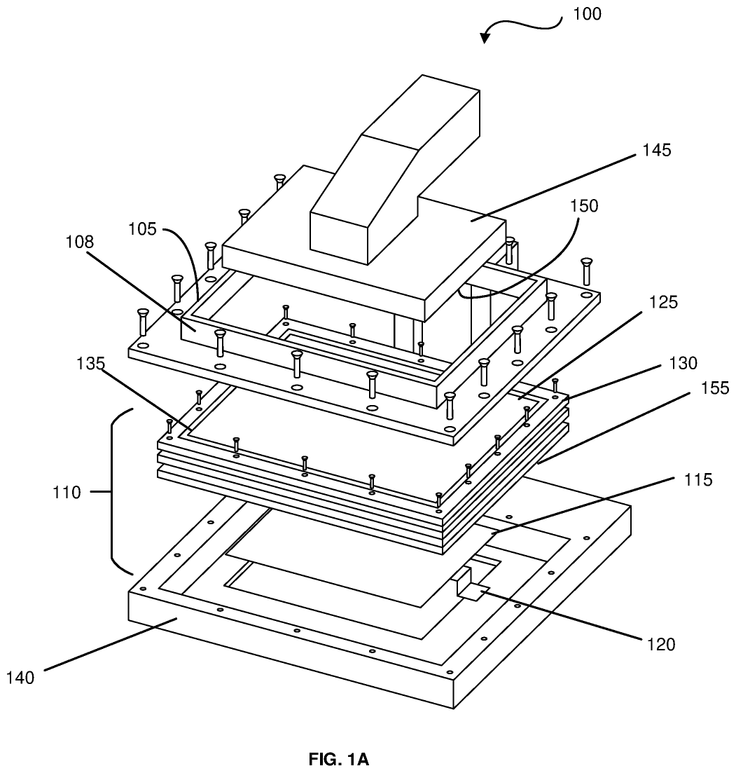

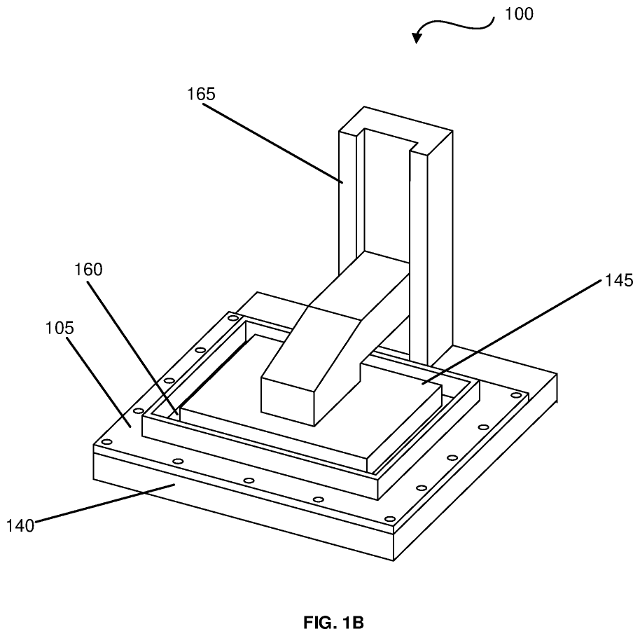

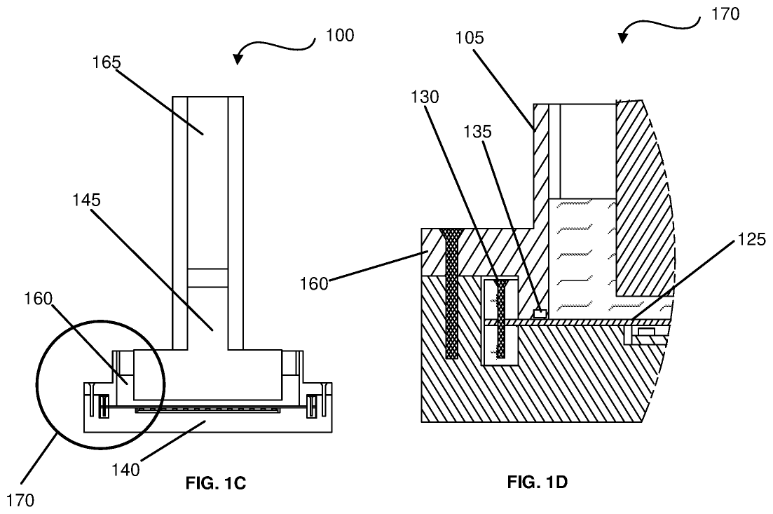

Referring to FIGS. 1A and 1B, there are shown schematic views of an additive manufacturing device 100 according to some implementations of the present specification. In particular, FIG. 1A shows an exploded schematic view of the additive manufacturing device 100, and FIG. 1B shows a corresponding non-exploded schematic view. The additive manufacturing device 100 is operable to produce an object. The additive manufacturing device 100 comprises a vessel 105 for containing a material 160 (e.g., resin) which is polymerizable on exposure to radiation. The vessel 105 may have sidewalls 108. In some implementations, the vessel 105 may have four sidewalls defining a rectangular or square internal region, but it may also have a single cylindrical sidewall or other configuration.

The additive manufacturing device 100 further comprises a programmable radiation module 110, whose top surface, hereafter referred to as “irradiation surface”, forms a lower wall of the vessel 105. In some implementations, the programmable radiation module 110 may be attached to the vessel 105, and the irradiation surface of the programmable radiation module 110, forms the lower wall of the vessel 105 and is thus in direct contact with the material 160 contained in the vessel 105. The programmable radiation module 110 may be positionable for the irradiation surface of the programmable radiation module 110 to be in direct contact with the material 160.

The programmable radiation module 110 is configured to produce a radiation pattern. The programmable radiation module 110 is positionable to irradiate uncured material adjacent the irradiation surface. The programmable radiation module comprises an array 115 of individually addressable radiation emitting elements. The array 115 may be placed in close contact with the material 160 (e.g., liquid photo-curable resin) which solidifies when exposed to light emitted by the array 115. The array 115 can be configured to emit a patterned beam of radiation to cure the material 160 in the vessel 105 with a desired pattern. The individually addressable radiating emitting elements of the array 115 may be switched on or off by a control system (not shown in the drawings) of the device 100, which is coupled to the array 115 through electrical connections 120. When the radiation emitting element is activated (switched on), it emits the light, whereas when it is inactive (switched off), it does not emit light. Accordingly, the radiation emitting elements of the array 115 can be programmed by the control system to produce the desired pattern of radiation. The individually addressable radiation emitting elements of the array 115 may, in principle, be designed to emit any particular wavelength of light (e.g., visible, ultraviolet (UV), or infrared (IR)) to match the specific curing requirement of the polymerisable material 160.

The array 115 is supported by a substrate backplane 140 underneath the array 115, which provides electrical connectivity 120 to terminals of each radiation emitting element while also serving as a mechanical support.

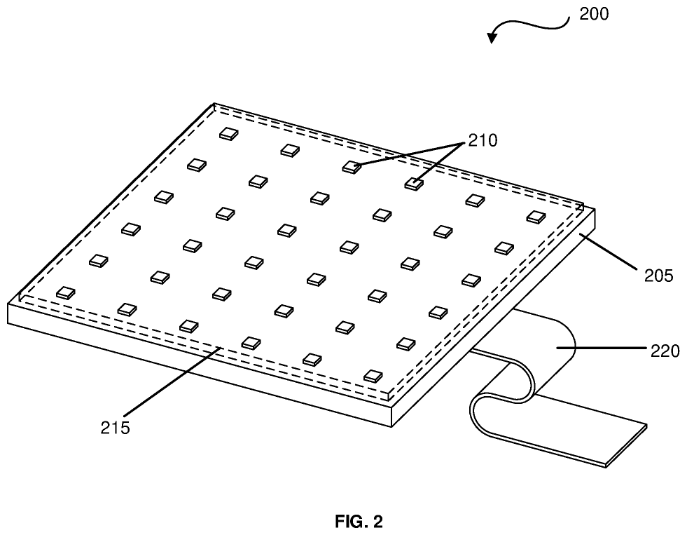

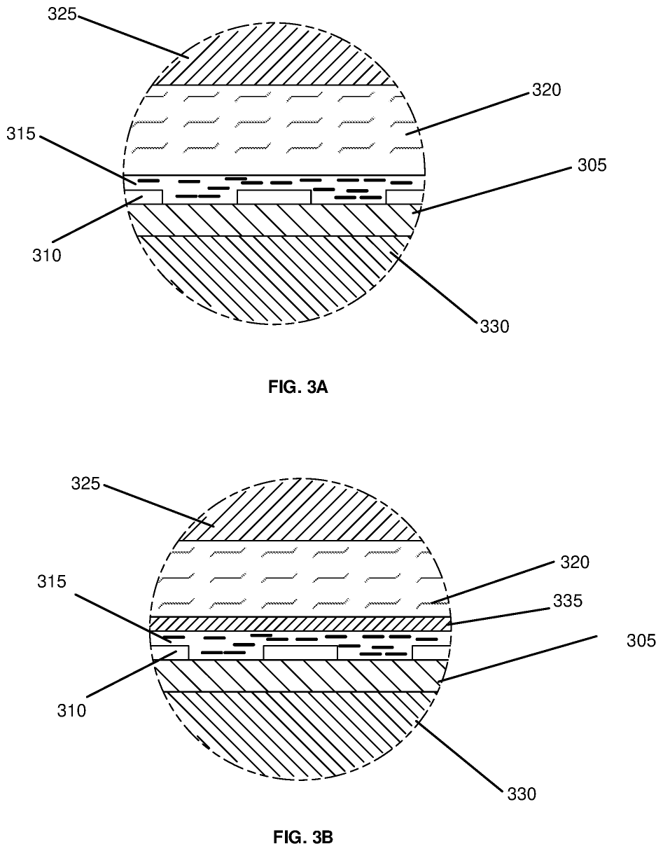

In some implementations, the array 115 may comprise a plurality of micro light emitting diodes (LEDs) on a substrate as the individually addressable radiation emitting elements. Each micro LED may be switched ON or OFF to generate the particular radiation pattern. Micro LED display is a new emerging technology that is being developed for the next generation of LED displays and imaging applications. When compared with widespread LCD technology, micro LED display offers better contrast, response times, and energy efficiency. Micro LEDs generate their own light and do not require a backlight. Hence, the Micro LED array offers greatly reduced energy requirements when compared to conventional LCD systems. Moreover, Micro LEDs offer far greater total brightness and do not suffer from burn-ins. Such a micro LED array formed of micro LEDs is explained in more detail in relation to FIGS. 2, 3A, and 3B.

The array 115 may be sized to cover substantially the entire surface area of the irradiation surface, such that substantially the entire volume above the irradiation surface is a printable volume. In some implementations, the array 115 may cover a surface area which is smaller than the surface area of irradiation surface.

In some implementations, the programmable radiation module may further comprise a clear non-stick film 125. The non-stick film 125 forms a lower wall of the vessel 105. In other words, the film 125 may form the irradiation surface of the programmable radiation module 110, which may be in direct contact with the material 160 contained in the vessel 105. The vessel 105 may comprise tensioners, clamps, or other similar components 130 which may set and hold the film 125 in place. In some implementations, a sealing material may be applied around edges of the film 125 in order to form a seal 135 between the walls of the vessel 105 and the film 125. The seal 135 may be formed from a material such as epoxy which is cured in situ to seal the vessel, but it could also be a solid seal such as a rubber (nitrile or viton, for example) O-ring or gasket.

In some implementations, the film 125 may be a polyurethane film, a flexible transparent material, a flexible translucent material, or another material that may be apparent to those skilled in the relevant art after reading the description herein. In some implementations, a silicone sheet may be used as the film 125. A silicone sheet is preferred, as it is transparent and non-consumable. The non-stick film 125 may be made as thin as possible, since a thinner layer between the array 115 and the material 160 to be cured means that there is less divergence of the light transmitted from the array 115 before it reaches the material 160, thus resulting in a physical printing resolution closer to the array 115.

In some implementations, liquid coatings including mould release agents such as CHEMLEASE (registered trade mark) of Chem-Trend LP of Michigan, or solid sheets or coatings such as polyurethane, polytetrafluoroethylene (PTFE), fluorinated ethylene propylene (FEP) or latex can be used as the film 125, so long as the material is transparent to the wavelength of light being used as a curing initiator and can be made sufficiently thin so as to prevent substantial resolution loss between a resolution of the array 115 and the physical printing resolution. FEP may be preferred as it tends to be more transparent than PTFE at most curing wavelengths. In some implementations the film 125 may be a Teflon FEP film. The Teflon FEP film may be a tensioned FEP film.

If the film 125 forms the irradiation surface, its thickness should be chosen to minimize divergence of the beam produced by an emitter of the radiation module 110 as the beam undergoes diffusion through the coating. In particular, at the point where it reaches the layer of polymerizable material which is to be cured, the beam should preferably cover an area which is less than four times the emitter surface area (e.g., for an array with emitters measuring 50×50 microns, the light passing through that emitter should not be larger than 100×100 microns when it reaches the layer). If it is any larger, it will overlap the beams produced by its neighboring emitters by more than 25 microns, i.e. more than halfway into the neighboring emitters such that the neighboring emitters are no longer resolvable. Preferably, the film or the encapsulant layer results in radiation beams at the curing layer which have a surface area which is no more than 1.2× the array surface area. This can be achieved by making the irradiation surface very thin. If a sufficiently thin film or encapsulant cannot be selected, optics such as lenses or reflectors or an array thereof may be used to correct for the diffusing effects of the addition of a film or encapsulant by collimating the light prior to it passing through the irradiation surface, so that the beam travelling through the irradiation surface is less divergent. For example, if a PTFE or FEP sheet is used as the film 125, it may have a thickness of approximately 70 μm. A thickness of under 50 μm may also be used. Typically, a film thickness which is less than or equal to the emitter-to-emitter distance (resolution of the array) is desirable.

In some implementations, the additive manufacturing device 100 may not comprise the film 125. In some implementations, the array 115 may be encapsulated in a thin transparent material that forms an encapsulant layer at a face of the programmable radiation module 110. The encapsulant layer may form the irradiation surface of the programmable radiation module 110. In other words, the encapsulant layer, which encapsulates the array 115 may be in direct contact with the material 160 in the vessel 105. In some implementations, the encapsulant material may be Polydimethylsiloxane (PDMS).

In some implementations, the additive manufacturing device 100 may comprise both the film 125, and the encapsulated array 115. For example, the array 115 may be encapsulated in thee thin transparent material that forms the encapsulant layer at the face of the programmable radiation module 110, and the encapsulant layer at the face of the array 115 may be in contact with the film 125 which may form the irradiation surface of the programmable radiation module.

The additive manufacturing device 100 further comprises a build platform 145 that is moveable relative to the vessel 105. In some implementations, the build platform 145 is capable of moving or being made to move vertically upwards relative to vessel 105 above the programmable radiation module 110, by means of a mechanical assembly 165 which may comprise ball screws, lead screws, belt drive mechanisms, a chain and sprocket mechanism, or a combination thereof, and a precision stepper motor, servo motor, or other means of drive. In some implementations, the mechanical assembly 165 comprises threaded rods and stepper motor, which is driven by a microcontroller of a control system of the device 100 (not shown in the drawings) and which can provide 5 μm precision in the vertical position of the build platform 145. The combined mechanical assembly and stepper motor may be fixed upon or connected to a frame which is supported on the sidewalls 108. The frame provides rigid support and a reference point for the vertical position of the build platform 145. Greater precision (up to about 1 μm) may also be achieved through a suitable choice of lead screw or belt pitch and the resolution (steps per full revolution) of the stepper motor.

The build platform 145 comprises a build surface 150 onto which layers of the object are progressively printed. The progressive printing of the object includes that the first layer of a given object is printed onto the build surface 150, where after subsequent layers adhere to preceding layers to form the printed object. The build surface 150 faces towards the lower wall of the vessel 105, which is formed by a top surface (e.g., irradiation surface) of the programmable radiation module 110. The build platform 145 is suspended inside the vessel 105 above the programmable radiation module 110 of the additive manufacturing device 100, and faces towards the irradiation surface of the programmable radiation module. As described previously, the irradiation surface may be the film 125 or the encapsulant layer formed at the face of the array 115 by the material encapsulating the array 115. The build surface 150 of the build platform 145 may have a surface area equal to or slightly smaller than that of the array 115 such that the perimeter of the build surface 150 fits inside the perimeter of the array 115.

In some implementations, the additive manufacturing device 100 may further comprise an optical assembly 155 that is configured to modify the radiation generated by the array 115 of the programmable radiation module 110. The optical assembly 155 may comprise various optical components capable of diffusing, collimating, reflecting, or refracting light generated by the programmable radiation module 110. Generally, the optically assembly 155 comprises diffusing and collimating elements. In some implementations, the optical assembly 155 may be a part of the programmable radiation module 110. In an example implementation, the optical assembly 155 may comprise an array of convex lenses that aligns one lens with one radiation emitting element, so that the diverging cone of light emitted from an individual radiation emitting element is narrowed (e.g., collimated to an extent). In some implementations, the optical assembly 155 may be omitted, and the programmable radiation module 110 may generate the radiation pattern without magnification.

The front cross-sectional view of the additive manufacturing device 100 is illustrated in FIG. 1C. FIG. 1D illustrates an exploded view of a section 170 of the additive manufacturing device 100. As can be seen in FIG. 1D, the vessel 105 is filled with the material (e.g., resin) 160, and the programmable radiation module 110 is positioned such that the film 125 (forming the irradiation surface) is in contact with the polymerisable material 160 inside the vessel 105. In implementations, wherein the film 125 is omitted, the encapsulant layer at the face of the array 115, as described previously, may be in direct contact with the material 160.

Referring to FIG. 2, an example micro light emitting diode (LED) array 200 that may be implemented as the array 115 in an additive manufacturing device (e.g., device 100) is illustrated. The micro LED array 200 consists of microscopic LEDs 210. The micro LED array 200 may be placed in close contact with a liquid photo-curable resin (e.g., material 160) which solidifies when exposed to light emitted by the micro LED array 200. The micro LED array 200 comprises individually addressable micro LEDs 210 arranged on a backplane substrate 205. The substrate 205 may be flexible or rigid, and may be made of any suitable material such as a silicon, glass substrate or polymer sheet or the like. The substrate 205 underneath the micro LEDs 210, provides electrical connectivity 220 to the terminals of each micro LED 210 while also serving as a mechanical support. In some implementations, the substrate 205 may be passive with electrical traces only. In some implementations, the substrate 205 may be active and have active thin-film electronic structures on it. The individual micro LEDs 210 may be assembled on the substrate by a process, such as but not limited to, pick and place (e.g. using robotic arms), or any other process (e.g., epitaxy process) that enables arranging and assembling the micro LEDs. In some implementations, each micro LED 210 may be in the dimension range of less than 1 micron (μm) to 1000 micron, but preferably less than 25 micron.

The micro LED array 200 cures the polymerisable material (e.g., resin) with 2D patterns to solidify the material layer by layer. The first layer is built upon a build surface (e.g., build surface 150) which moves away from the micro LED array 200 after completion. Subsequent layers are built upon previous ones as the build platform (e.g., build platform 145) is moved away after each layer to create a 3D volumetric form as desired.

The micro LEDs 210 may emit monochromatic light that is suitable for curing of 3D printing resins such as 385 nm or the like. In some implementations, all micro LEDs 210 may operate at the same wavelength. In some implementations, the micro LED array 210 may comprise different type of micro LEDs, which may differ in wavelength at which they operate. In other words, micro LEDs 210 may operate at a different wavelengths that are suitable to cure the material 160. Each micro LED may be individually switched on and off and set to intermediate intensities thereby creating arbitrary patterns of varying intensities across the substrate area. Intermediate intensities may refer to 8-bit systems (e.g., choose 256 levels in between ON (255) and OFF (0)) or a system with more (or fewer) bits or virtually any intermediate intensity to create arbitrary patterns.

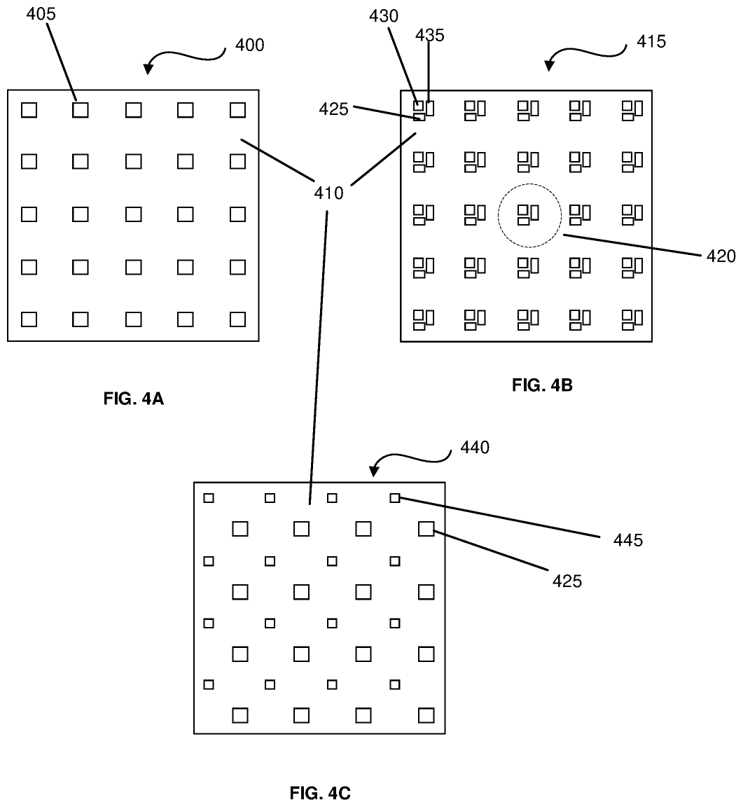

In some implementations, the micro LED array 200 may comprise multiple clusters of micro LEDs, where each cluster of micro LEDs may comprise of a set of micro LEDs which are individual LED sources of different wavelength radiation. The micro LEDs in the cluster may be individually addressable or the whole cluster may be controlled as a single multi-wavelength emitter. In some implementations, each cluster of micro LEDs may comprise micro LEDs that operate at the same wavelength, which may be different from the wavelength at which the micro LEDs in another cluster operate at. Alternatively, patterns of different wavelength emitters can be interspersed or arranged in any way that enables a successful print (FIGS. 4B and 4C).

In some implementations, the micro LED array 200 may be encapsulated in thin transparent material (e.g., PDMS) to protect it from damage. The encapsulation may also be of any thickness. The encapsulation may coat the micro LED array 200 to give it a uniform flat surface and prevents resin leak onto the emitters 210 below. Having an encapsulant that can be more easily scraped off or wiped down in the event of a leak protects the underlying emitters 210 from damage. The encapsulation of the array 200 forms an encapsulant layer 215 at a face of the programmable radiation module (e.g., module 110), and wherein the encapsulant layer 215 forms the irradiation surface of the programmable radiation module.

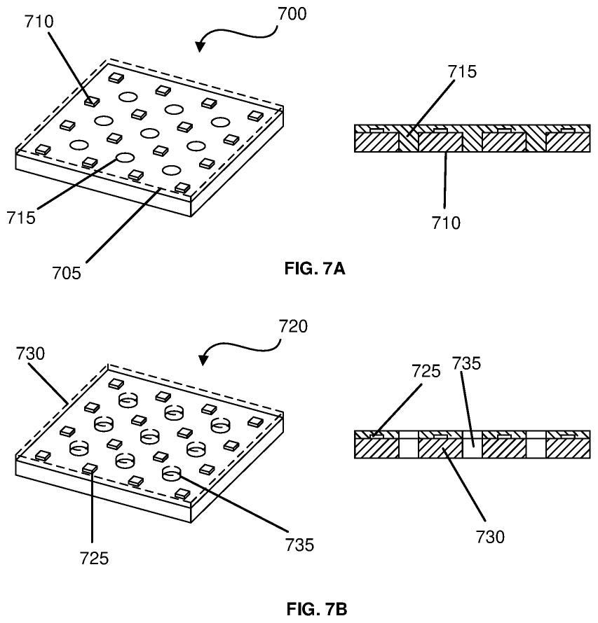

Alternatively, in some implementations, the array 200 may comprise micro LEDs 210 that are individually (or separately) encapsulated (instead of the whole array 200 being encapsulated in a single layer of material). Such individual encapsulation of the micro LEDs 210 may result in formation of a separate encapsulant layer at a face of each of the micro LEDs 210. The individual encapsulation of the micro LEDs is discussed in detail in relation to FIGS. 7A and 7B.

FIGS. 3A and 3B illustrate positioning of a programmable radiation module comprising a micro LED array in an additive manufacturing device. Referring to FIG. 3A, micro LEDs 310 are arranged on a substrate 305. Underneath the substrate 305, a mechanical base 330 is provided which provides mechanical support to the micro LEDs 310 and the substrate 305. The micro LED array formed by the micro LEDs 310 and the substrate 305 is encapsulated in a transparent material 315. The encapsulant material 315 form an encapsulant layer at a face of the micro LED array, and is in direct contact with the polymerisable material 320 in a curing region. The build platform 325 comprises a build surface onto which layers of the object to be manufactured are progressively printed. is suspended inside the vessel containing the material 320 and faces towards the irradiation surface formed by the encapsulant 315 covering the micro LEDs 310.

FIG. 3B illustrates an alternative implementation where the programmable radiation module comprises a film that forms an irradiation surface of the programmable radiation module. As can be seen in FIG. 3B, the film 335 of the programmable radiation module is disposed between the array of micro LEDs 310 and the polymerisable material 320. Therefore, instead of the encapsulant material 315, the film 335 is in direct contact with the material 320. Thus, the non-stick film or layer 335 made of a material such as but not limited to PTFE, FEP, silicone or the like, keep the material (e.g., liquid resin) 320 away from the micro LEDs 310 and helps the solidified resin to separate from it after being cured. In some implementations, where the protective film 335 is provided, the micro LEDs 310 may not be encapsulated by the encapsulant 315.

FIGS. 4A, 4B, and 4C illustrate different example emitter arrangements of a micro LED array. As described previously, the micro LED array (e.g., array 200) comprises an individually addressable micro LEDs (e.g., micro LEDs 210). In some implementations, the micro LED array may comprise micro LEDs (emitters) of same type arranged on a substrate (FIG. 4A). As can be seen in FIG. 4A, the micro-LED array 400 comprises a rectangular grid of emitters of a same type 405 arranged on a substrate 410. The emitters 405 may operate at a same wavelength.

In some implementations, the micro LED array may comprise emitters of different types (FIG. 4B). As can be seen in FIG. 4B, the micro LED array 415 comprises clusters 420 of micro LEDs, each cluster 420 is made up of three different types of micro LEDs 425, 430, and 435 arranged on the substrate 410. Stated in another way, each micro LED 425, 430, 435 is an individual emitter operating at a different wavelength. Micro LEDs or emitters 425, 430, and 435 may be individually addressable or the whole cluster 420 may be controlled as a single multi-wavelength emitter. When the array comprises emitters of different types (e.g., emitters operating at different wavelengths) such as array 415, the array may be controlled to dynamically switch ON or OFF different emitters to selectively expose certain regions of a print area (e.g., whole or a part of the print area) to a particular wavelength radiation (based on which emitters are ON). Such multi-wavelength operation may be used for multiple purposes such as (i) resins which require multiple wavelengths for complete curing, (ii) to make a single printer compatible with different resins which require different curing wavelengths (iii) for multi-part resins which may result in varying properties such as color, flexibility, and opacity across the volume of a printed part by varying the curing wavelength at each point.

In some implementations, the micro LED array may comprise different types of micro LEDs interlaced with each other (FIG. 4C). As can be seen in FIG. 4C, the array 440 comprises two sets of different LEDs types 425, 445 each set forming a separate rectangular grid. It is contemplated, that the micro LED emitters may be arranged on a substrate in any fashion (such as circular configuration or the like), and are not limited to forming a rectangular grid. As described previously, patterns of different wavelength emitters can be interspersed or arranged in any way that enables a successful print.

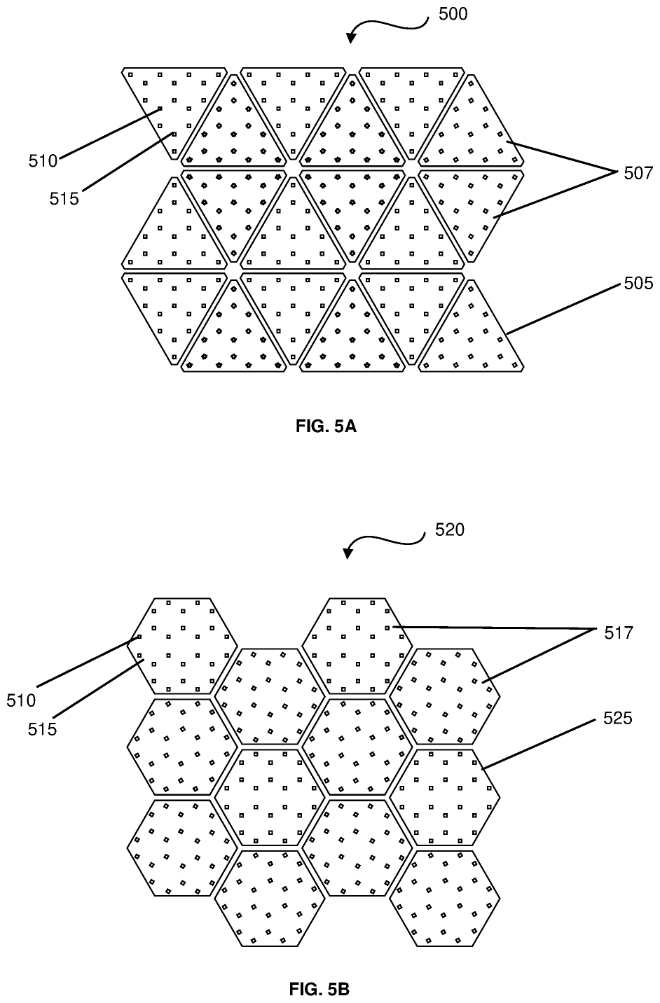

FIGS. 5A and 5B illustrate a tessellated structure of an example micro LED array. In some implementations, the array (e.g., micro LED array 200) of the programmable radiation module may comprise a plurality of tessellated members (sub-arrays), each tessellated member comprising a plurality of micro LEDs. Each tessellated member comprising a plurality of micro LEDs and forming the micro LED array may be of any shape such as, but not limited to a square, rectangular, triangular, or hexagonal shapes. Each tessellated member may be filed to from a continuous plane of larger area thus defining the micro LED array. FIG. 5A illustrates such tessellated structure of the micro LED array 500 formed of a triangular shaped tessellated members 505, each tessellated member 505 comprising a plurality of micro LEDs 510 arranged on a respective substrate 507, and a plurality of pores 515 interspaced between the micro LEDs 510. Similarly, FIG. 5B illustrates the micro LED array 520 formed of a hexagonal shaped tessellated members 525, each tessellated member 525 comprising a plurality of micro LEDs 510 arranged on a respective substrate 517, and a plurality of pores 515 interspaced between the micro LEDs 510.

In some implementations, the substrates of the micro LED array formed of the tessellated members may be rigid, and the tessellated members such as 505, 525 may be flexibly linked such that the entire array act like a film. For example, the triangular tessellated members 505 may have an individual rigid substrate underneath the micro LEDs, and the tessellated members 505 may be joined along their edges, in such a way that the edges act like hinges. Then the overall patchwork of such tessellated members would be able to provide a flexible peeling-like motion to release printed objects, and the bending radius at any point would be a function of how large the tessellated members are. The smaller each tessellated member is, the more like a smooth curvature it can approximate. Also, the flexible linking of the tessellated members may enable to achieve flexibility (which may be important to provide peeling-like motion to release printed objects) even while using the rigid substrates (which may be easier to fabricate than the flexible ones).

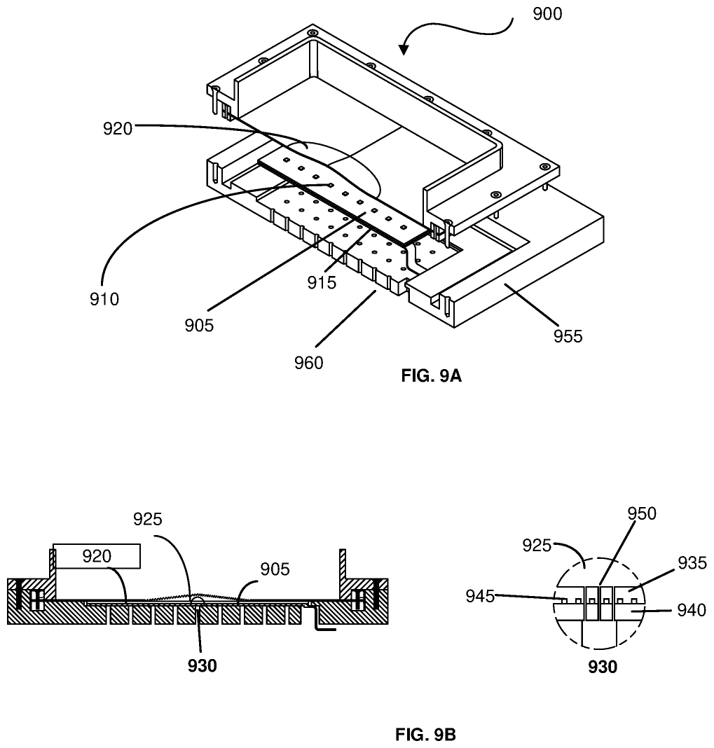

The pores in the micro LED arrays 500 and 520 may provide a route for continuous venting or air bubble that may form between the micro LED array and a non-stick film (e.g., film 135) of the additive manufacturing device. The micro LED arrays 500 and 520 may be made porous by creating pores 515 in the substrate and any other layers if any exist. The pores 515 may be produced by lithographically etching the substrate medium before placing the micro LEDs on it, or by drilling with lasers or any other similar method. The pores 515 may be made of any size that may be suitable for bubble venting. If the micro LED array is covered by an encapsulant, the encapsulant layer can be drilled through as well. The pores 515 may be sized and placed so that so that the pores 515 not overlap actual led sources or any circuit traces in the substrate medium. The pores 515 may occupy empty regions or unused regions of the substrate. The pores may be placed near every micro LED, or spaced every few micro LEDs, or placed in some regions of the device or any other arbitrary way or the like (FIG. 9).

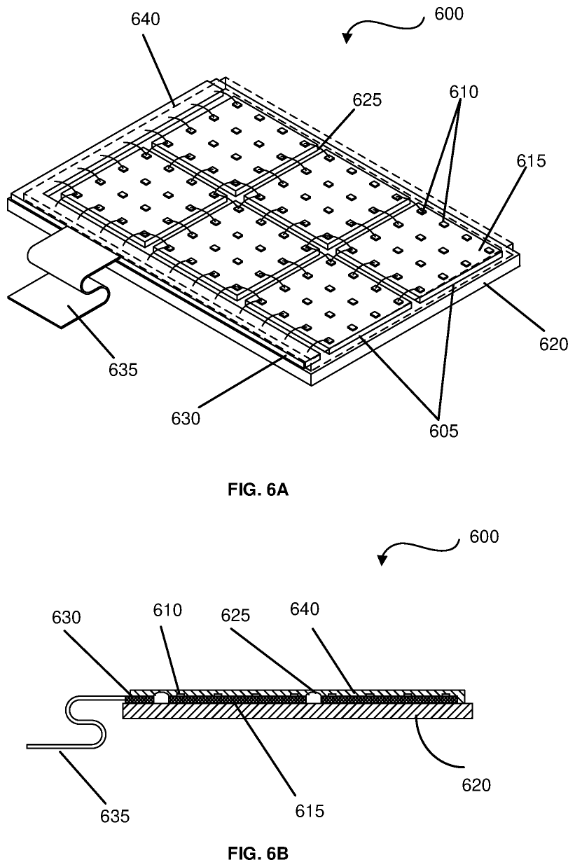

Referring to FIGS. 6A and 6B, a three-dimensional and a cross-sectional view of a micro LED array 600 comprising tessellated members 605 is illustrated. The tessellated members 605 comprise micro LEDs 610 on the substrate 615, which is supported on the mechanical base 620 that provides mechanical support to the substrate 615 and the tessellated members 605 formed of micro LEDs 610. Though tessellated members 605 are shown to be rectangular in shape, however they may be provided in any shape and size. It is contemplated that the tessellated members 605 be preferably small in size as it increases the percentage yield rate and reduces waste (e.g., manufacturing cost). In some implementations, the dimensions of a group of emitters on each tessellated members may be from about 100 μm to about 100 mm, preferably from about 1 mm to 10 mm. The small size of the tessellated member enables the member to be fitted in any size of 3D printers. The micro LEDs 610 may be placed on the tessellated members such that when the tessellated members are tiled together, the resulting plane has the same regular distribution across it as each individual member with no disruption at the seams. The tessellated members 605 are electrically connected to each other and the circuit board 630 by wire bonds 625. It is contemplated that the tessellated members may be individually wired to the driving electronics 635 from below, or they may be electrically connected to neighboring members using other methods such as, welding, soldering, using spring contacts or the like.

The micro LED array 600 is illustrated to be encapsulated in a transparent material forming an encapsulant layer 640 at a face of the array 600. It is contemplated that in some implementations, each tessellated member 605 of the array 600 may be individually encapsulated, thus forming a separate encapsulant layer at a face of each tessellated member 605, and gaps between the tessellated members 605 may have no encapsulant material covering them. In some implementations, the gaps between the tessellated members 605 may have a gas permeable encapsulant material covering them.

Referring to FIGS. 7A and 7B, gas diffusion through a porous micro LED array is illustrated. As described previously, the micro LED array may be made porous for the purposes of bubble venting. It is contemplated that the pores in the micro LED array may also be used for facilitating gas diffusion. For example, the micro LED array comprising micro LEDs may be made porous so that it may diffuse gases into the polymerisable material (e.g., resin) to affect resin chemistry. The pores in the array may be dimensioned such that the active gas may diffuse from below the substrate to the resin being cured above, while still preventing the resin from flowing in the reverse direction due to surface tension. For example, oxygen may be diffused from below through the pores in the array into the resin for resin oxygenation. Oxygen serves to inhibit photocuring of certain photosensitive resins. If oxygen is diffused into the region of resin immediately in contact with the micro LED array, it will create a dead layer of resin which will not cure, thereby preventing the printed part from bonding to the micro LED array surface. This may be achieved by maintaining oxygen at a high concentration or pressure below the micro LED array device which diffuses through the microporous structure.

In some implementations, the pores may be filled with an optically clear encapsulating material such as, but not limited to, PDMS. In some implementations, the encapsulating material may be permeable to a gas (e.g., oxygen permeable). Since the pores in the micro LED array may be filled with encapsulating material that is oxygen permeable or any material that allows oxygen permeation, or the like, fabricating pores in between the light emitters on the array, allows permeability to air or oxygen, which may be supplied directly from behind the array. For example, the rear face of the micro LED array may be attached to a pressurized supply of oxygen or other gas, to encourage faster diffusion of oxygen through the array.

In some implementations, the same encapsulant that fills the pores may be used to seal off the top of the micro LED array. In such implementations, the polymerisable material (e.g., liquid resin) may be poured directly on the encapsulant. The film (e.g., film 155) may be omitted in such implementations e.g., the Micro LED array assembly (including encapsulant) forms the bottom of the vessel (e.g., vessel 105). The diffusion of oxygen through the permeable substrate and the permeant encapsulant layer over the array provides several advantages. One such advantage being that oxygen is a cure-inhibitor, i.e. resin will not cure when it is exposed to oxygen (even when illuminated with UV light). This means that an oxygen permeable micro LED array creates a “dead zone” for several micrometers above its surface, where no curing can take place. The depth of this zone depends on how far the oxygen permeates into the resin. The creation of such “dead zone” enables continuous printing, instead of in discrete layers, and also at a much faster rate. The actual printing takes place a slight distance from the micro LED array, but the key is that that gap is filled with resin as well, so there is a constant and uniform supply of fresh resin from underneath the printing interface. This means the build platform does not need to move up- and down-in order to generate reflow of resin after each printed layer, saving significant amounts of time per printed layer. The other advantage being that platform can now move upward in a continuous (rather than discrete) fashion, with the projected image also changing continuously, causing the printed part to be built up without visible layer lines and with technically infinite resolution along the z-axis. The continuous layer-less printing also results in improvement of physical properties of the printed object. For example, if there is no distinct layering (as achieved with the air or gas diffusion through the permeable micro LED array), the final printed part achieves isomorphic strength, e.g., has identical mechanical properties in X, Y and Z directions, which is comparable to molded alternates. Also, the present specification provides for oxygen permeation through the actual light emitting array, rather than a transparent window which requires the light source to be at a distance (e.g., restricting one to laser SLA or DLP, which both have accuracy and scalability issues).

Turning now to FIG. 7A, whole of the micro LED array 700 is shown to be encapsulated with an optically clear encapsulating material 705, which results in formation of the encapsulant layer over the micro LEDs 710 and the pores 715 between the micro LEDs 710. FIG. 7B shows an alternative implementation, where micro LEDs 725 of the micro LED array 720 are individually encapsulated by a transparent material 730. The pores 735 between the micro LEDs 725 are shown to be not encapsulated.

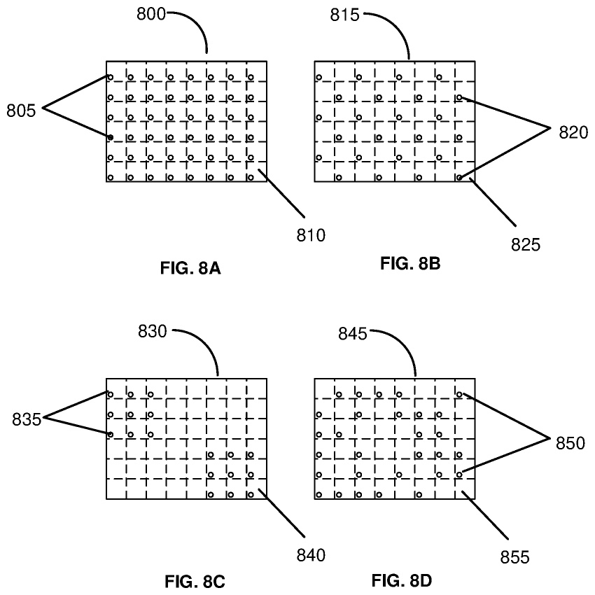

FIGS. 8A, 8B, 8C, and 8D illustrate pores placement in an example micro LED array according to some implementations of the present specification. The pores on the micro LED array may be sized and placed so that so that the pores do not overlap actual led sources or any circuit traces on the substrate of the micro LED array. The pores may occupy empty regions or unused regions of the substrate. The pores may be placed near every micro LED, or spaced every few micro LEDs, or placed in some regions of the device or any other arbitrary way or the like. In FIG. 8A, the micro LED array 800 is shown to comprise pores 805 on the substrate 810 equidistant from each other. In FIG. 8B, the micro LED array 815 is shown to comprise pores 820 created intermittently on empty or unused regions on the substrate 825. In FIG. 8C, the micro LED array 830 is shown to comprise pores 835 clustered on empty or unused regions on the substrate 840. In FIG. 8D, the micro LED array 845 is shown to comprise pores 850 created randomly or arbitrarily on empty or unused regions on the substrate 855.

FIGS. 9A and 9B illustrate a 3D and a cross-sectional view respectively of a section of an additive manufacturing device 900 employing a porous micro LED array 905. The porous micro LED array 905 comprises pores 910 which extend through the substrate 915. The pores 910 in the array 905 may allow for air or gas (e.g., oxygen) to pass from underneath the array 905 toward the non-stick film 920 which results in lifting of the film 920 as can be seen in FIGS. 9A and 9B. In other words, the pores 910 in the array 905 may provide a route for continuous venting or air bubble that may form between the micro LED array 905 and a non-stick film 920 of the additive manufacturing device 900. The pores 910 in the micro LED array 905 may also facilitate resin oxygenation as described previously. As can been seen in a detailed view of the section 930 of the additive manufacturing device 900, a gas bubble 925 may pass through a pore 950 between the micro LEDs 945 arranged on the substrate 940 and encapsulated by an encapsulant 935. The pore 950 is shown to be not encapsulated by the encapsulant 935. However, it is contemplated, that the pore 950 as well as other pores 910 of the array 905 may be encapsulated by a gas permeable encapsulant material, which may still allow for the gas bubble to pass through the pores on the array.

FIG. 9A further shows a mechanical base 955 onto which whole of the array assembly 905 is mounted onto. The base 955 has pillar-like supports 960 to mount the assembly thereon to while maintaining a supported hollow region for gas flow. The support pillars 960 may be made short and thick and spaced close together to maximize stiffness of the assembly, and as the gas flow rate is very low, the resulting reduced cross-section for airflow may not be an issue. The pillars 960 may be assembled by gluing, thermal welding, or any other similar technique. The rear face of the micro LED array 905 may be attached to a supply of oxygen or other gas, to encourage faster diffusion of oxygen through the array. Airpath for the oxygen or other gas may be convoluted or it may be fed separately in pockets). The base 955 may comprise a mechanical structure that may prevent the pressurized gas from bending the array 905 (e.g., substrate 915). As squeezing a gas through very small pores, there is a pressure build-up below the array 905, the mechanical structure of the base 955 may keep the array assembly stiff.

In some implementations, rather than diffusing gas from below the porous micro LED array upwards through it, the gas may also be fed through the micro LED array. For example. the micro LED array may have a hollow inner core built into the substrate. The hollow inner core may be built into the substrate by bonding two wafers of silicon substrate together after performing reactive ion etching lithographically on inner surfaces to hollow out cavities on the face of the substrate. Gas may then be fed into the hollow core of the micro LED array through a port from where it travels across the device and diffuses out through the micropores. In this configuration, the reverse side of the micro LED array may be directly bonded, to a support structure with no other particular requirements. The backing plate to the micro LED array may then also serve as a heatsinking base plate or, simply, a strong mechanical support. In this configuration, increasing the gas pressure will not cause bowing of the micro LED array since the pressure is delivered from within the core itself.

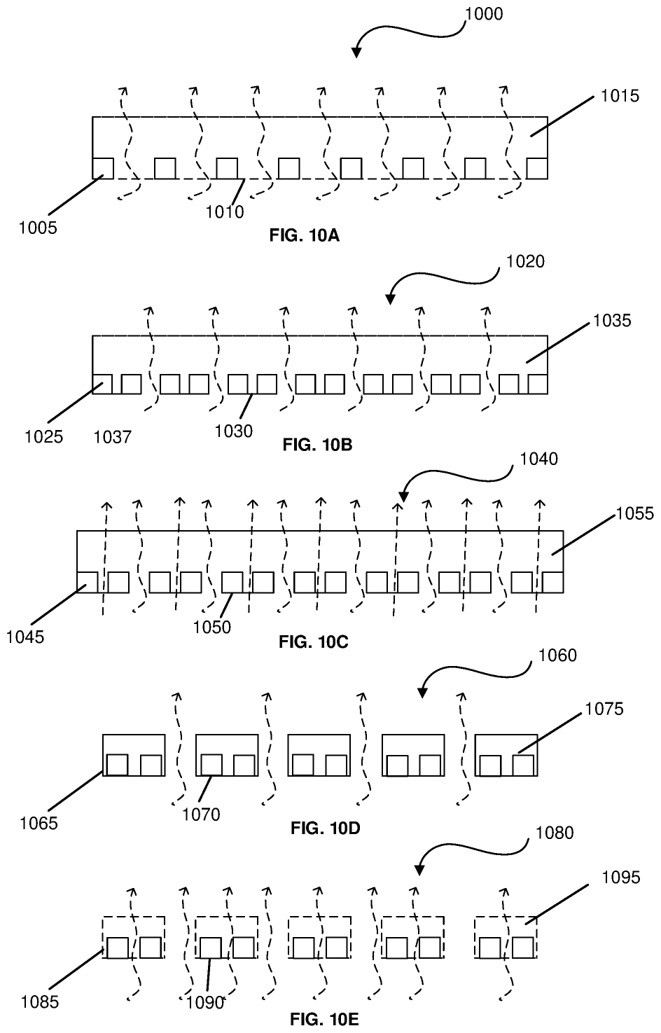

Gas diffusion through the micro LED array (e.g., for resin oxygenation) may be implemented in various ways as illustrated in FIGS. 10A-10F below. FIG. 10A illustrates an implementation where whole of the micro-LED array 1000 comprising of micro LEDs 1005 arranged on the substrate 1010 is wholly encapsulated by an optically clear encapsulant material forming an encapsulant layer 1015 at a face of the micro LED array 1000. As can be seen in FIG. 10A, both substrate 1010 and the encapsulant layer 1015 are permeable to a gas (e.g., oxygen) which allow for the gas (e.g., oxygen) to permeate through the substrate 1010 and the encapsulant layer 1015 towards the polymerisable material (e.g., resin) contained in the vessel. The permeability of the substrate 1010 and the encapsulant layer 1015 may be due to nature (e.g., natural porosity) of the material of the substrate 1010 and the encapsulant layer 1015.

FIG. 10B illustrates an implementation where whole of the micro-LED array 1020 comprising of micro LEDs 1025 arranged on the substrate 1030 is wholly encapsulated by an optically clear encapsulant material forming an encapsulant layer 1035 at a face of the micro LED array 1020. As can be seen in FIG. 10B, the encapsulant layer 1035 is permeable to a gas (e.g., oxygen) (e.g., due to its natural porosity), which allow for the gas (e.g., oxygen) to permeate through the encapsulant layer 1035 towards the polymerisable material (e.g., resin) contained in the vessel. The substrate 1030 is non-permeable to the gas, however pores may be created in the substrate 1030 that may allow for the gas (e.g., oxygen) to pass through the substrate.

FIG. 10C illustrates an implementation where whole of the micro-LED array 1040 comprising of micro LEDs 1045 arranged on the substrate 1050 is wholly encapsulated by an optically clear encapsulant material forming an encapsulant layer 1055 at a face of the micro LED array 1040. As can be seen in FIG. 10C, the substrate 1050 is permeable to the gas (e.g., oxygen) (e.g., due to its natural porosity), which allow for the gas (e.g., oxygen) to permeate through the substrate 1050 towards the encapsulant layer 1055. The encapsulant layer 1055 is non-permeable to the gas (e.g., the material of the encapsulant layer being non-porous), however pores may be created in the encapsulant layer 1055 that may allow for the gas (e.g., oxygen) to pass through the encapsulant layer 1055 toward the polymerisable material (e.g., resin) contained in the vessel of the additive manufacturing device.

FIG. 10D illustrates an implementation where a micro-LED array 1060 comprises of a plurality of tessellated members 1065 (sub-arrays) arranged on the substrate 1070, each tessellated member 1065 comprises multiple micro LEDs. Each tessellated member 1065 is individually encapsulated by an optically clear encapsulant material forming a separate encapsulant layer 1075 at a face of each of the tessellated member 1065. As can be seen in FIG. 10D, both the substrate 1070 and the individually encapsulate tessellated member 1065 are non-permeable to the gas (e.g., oxygen) (e.g., due to natural porosity of the substrate material and the encapsulant material). In such cases, pores may be created in the substrate 1070 which may align with gaps between the tessellated members 1065 that may allow for the gas (e.g., oxygen) to pass through the substrate 1070 and the tessellated members 1065 toward the polymerisable material (e.g., resin) contained in the vessel of the additive manufacturing device.

FIG. 10E illustrates an implementation where a micro-LED array 1080 comprises of a plurality of tessellated members 1085 (sub-arrays) arranged on the substrate 1090, each tessellated member 1085 comprises multiple micro LEDs. Each tessellated member 1085 is individually encapsulated by an optically clear encapsulant material forming a separate encapsulant layer 1095 at a face of each of the tessellated member 1085. As can be seen in FIG. 10E, both the substrate 1090 and the individually encapsulate tessellated member 1085 are permeable to the gas (e.g., oxygen) (e.g., due to natural porosity of the substrate material and the encapsulant material) Additionally, pores may be created in the substrate 1090 which may align with gaps between the tessellated members 1085 that may allow for the gas (e.g., oxygen) to pass through the substrate 1090 and the tessellated members 1085 (through the pores as well as the gaps between the tessellated members) toward the polymerisable material (e.g., resin) contained in the vessel of the additive manufacturing device.

Though FIGS. 2-10E are described in relation to an array comprising micro LEDs, however it is contemplated that the array described in such figures may comprise other type of radiation emitting elements in addition to or as alternate to micro LEDs. For example, other type of radiation emitting elements may comprise LEDs such as, but not limited to, conventional LEDs, organic LEDs (OLEDs), quantum LEDs (QLEDs), mini LEDs, or the like.

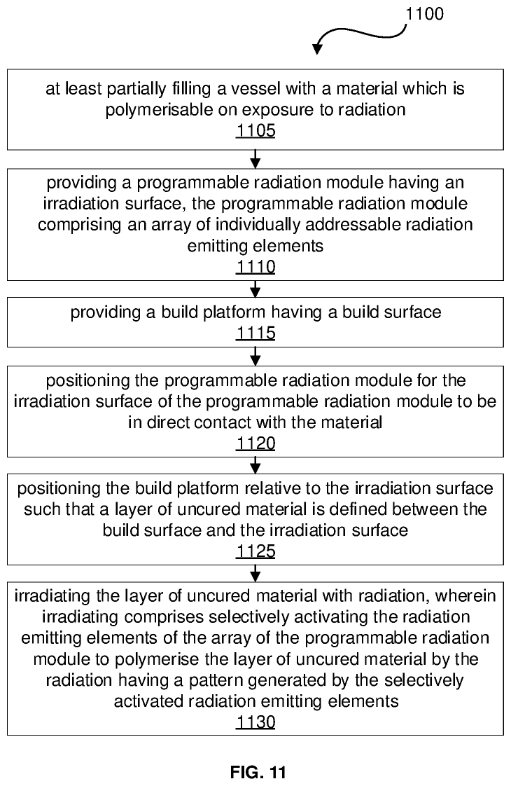

FIG. 11 illustrates a flow diagram of an example additive manufacturing method 1100 according to some implementations of the present specification.

At 1105, a vessel (e.g., vessel 105) is filled with a material (e.g., material 160) which is polymerisable on exposure to radiation.

At 1110, a programmable radiation module having an irradiation surface (e.g., programmable radiation module 110) is provided. The programmable radiation module 110 comprises an array 115 of individually addressable radiation emitting elements. In some implementations, the array 115 may be an array 200 comprising micro LEDs 210.

At 1115, a build platform (e.g., a build platform 145) having a build surface (e.g., build surface 150) is provided.

At 1120, the programmable radiation module (e.g., programmable radiation module 110) is positioned for the irradiation surface (e.g., defined by the non-stick film 125 or a top layer of the array 115) of the programmable radiation module to be in direct contact with the material (e.g., material 160).

At 1125, the build platform (e.g., build platform 145) is positioned relative to the irradiation surface such that a layer of uncured material is defined between the build surface (e.g., build surface 150) and the irradiation surface.

At 1130, the layer of uncured material is irradiated with radiation. To irradiate the layer of uncured material, the radiation emitting elements of the array (e.g., array 115 or array 200) of the programmable radiation module (e.g., 110) may be selectively activated to polymerise the layer of uncured material by the radiation having a pattern generated by the selectively activated radiation emitting elements. For example, once the layer of uncured material is defined between the build surface and the irradiation surface, the radiation emitting elements (e.g., micro LEDs) may be selectively activated in accordance with a desired radiation pattern. As a result of the patterned radiation, the thin layer of polymerisable material polymerizes in the regions which are exposed to radiation. Once the thin layer is cured in the desired manner, the build platform 145 may move vertically in order to release the cured layer. Next, the build platform 145 may move vertically relative to the programmable radiation module 110 so as to arrive at a position defining a subsequent layer of a desired layer thickness between the previously cured layer and the programmable radiation module 110. In other words, once the first layer is cured between the build surface and the irradiation surface, the build platform 145 may move vertically relative to the programmable radiation module 110, for the next layer to be cured between the first cured layer and the irradiation surface. Steps 1125 and 1130 are repeated for each next layer of the object to be built as the second layer (e.g., between the previously cured layer and the irradiation surface).

The present specification discloses additive manufacturing devices employing micro LED arrays that possess several advantages such as, but not limited to: (a) fixed pixel size, where the size of, and pitch between each emitter is established with a high degree of accuracy during the manufacturing process, negating the requirement for calibration of the device at any time during its useful life, (b) a modular system that is therefore highly scalable, where tessellated members are simply tiled together into a larger array without loss of resolution or intensity per unit surface area, (b) extremely high printing speed, as the light intensity can be 50× higher than conventional DLP or SLA based printers, and (c) no wavelength restrictions, as the array is designed such that the micro LEDs (e.g., encapsulated micro LEDs) can emit directly into the liquid resin without other barriers such as reflectors (like in DLP printers) or filters (like in LCD based printers). Hence, the use of micro LED array in the additive manufacturing devices as disclosed herein enables 3D printing with higher resolution, at larger scale, as well as greater brightness, better uniformity and higher efficiency than conventional 3D printing techniques, without the need for repeated calibration. Also, the micro LEDs are more durable and have a longer operational lifetime than existing radiation sources for 3D printing, such as laser, DLP projection, or LCD. In addition to these advantages, the Micro LED arrays as disclosed herein have a unique form factor (e.g., thin light-emitting surface) that allows the additive manufacturing device to be more compact, lightweight, and of lower cost compared to currently available devices. Further, the continuous, layer-free printing enabled by utilizing gas or oxygen diffusion as disclosed herein provides much faster manufacturing speed among other advantages. The approach of oxygen diffusion as disclosed herein could be easily scaled to additive manufacturing devices having a large form factor and may be used to print large objects such as, but not limited to components in the automotive industry (e.g. dashboard or bumper full scale prototype, mold, or jigs and fixtures).

Whilst there has been described in the foregoing description exemplary embodiments of the present invention, it will be understood by those skilled in the technology concerned that many variations and combination in details of design, construction and/or operation may be made without departing from the present disclosure. For example, stereolithography based additive manufacturing devices having bottom-up configuration are disclosed herein for illustrative purposes only, and that the systems and methods disclosed herein may be used for other different types of additive manufacturing devices too which may have different configuration such as, but not limited to, top-down configuration. In another example, the methods disclosed herein for continuous printing (e.g., by gas diffusion) may also be compatible with other 3D printers as well such as 3D printers based on MSLA, or any other similar currently available 3D printing techniques.

1. An additive manufacturing device, comprising:
a vessel containing a material which is polymerisable on exposure to radiation;
a programmable radiation module comprising an array of individually addressable radiation emitting elements, wherein:
the programmable radiation module is positionable for an irradiation surface of the programmable radiation module to be in direct contact with the material;
the array is programmable to produce radiation having a pattern by selective activation of the elements of the array, and
the programmable radiation module is positionable to irradiate the material adjacent the irradiation surface; and
a build platform having a build surface, the build platform being configured for movement relative to the irradiation surface.

2. The additive manufacturing device of claim 1, wherein the plurality of radiation emitting elements comprises a plurality of micro light emitting diodes (LEDs) on a substrate.

3. The additive manufacturing device of claim 2, wherein the micro LEDs are configured to emit monochromatic light.

4. The additive manufacturing device of claim 1, wherein the array comprises a plurality of tessellated members, and wherein each tessellated member comprises a plurality of radiation emitting elements.

5. The additive manufacturing device of claim 4, wherein the array comprises gaps between the plurality of tessellated members for a gas to permeate through the irradiation surface.

6. The additive manufacturing device of claim 1, wherein the array is encapsulated in a transparent material that forms an encapsulant layer at a face of the programmable radiation module, and wherein the encapsulant layer forms the irradiation surface.

7. The additive manufacturing device of claim 6, wherein the substrate and the encapsulant layer are permeable to a gas.

8. The additive manufacturing device of claim 5, wherein the array is encapsulated in a transparent material that forms an encapsulant layer at a face of the programmable radiation module, and wherein the encapsulant layer forms the irradiation surface.

9. The additive manufacturing device of claim 8, wherein the substrate is non-permeable to a gas, and wherein the encapsulant layer is permeable to the gas.

10. The additive manufacturing device of claim 8, wherein the substrate and the encapsulant layer are permeable to a gas.

11. The additive manufacturing device of claim 1, wherein the programmable radiation module comprises a non-stick film that forms the irradiation surface.

12. The additive manufacturing device of claim 1, further comprising:
an optical assembly configured to modify the radiation generated by the array of individually addressable radiation emitting elements.

13. The additive manufacturing device of claim 5, wherein each of the plurality of tessellated members is individually encapsulated by a transparent material.

14. The additive manufacturing device of claim 13, wherein the substrate, and the individually encapsulated tessellated members of the array are permeable to a gas.

15. An additive manufacturing method, comprising:
at least partially filling a vessel with a material which is polymerisable on exposure to radiation;
providing a programmable radiation module having an irradiation surface, the programmable radiation module comprising an array of individually addressable radiation emitting elements;
providing a build platform having a build surface;
positioning the programmable radiation module for the irradiation surface of the programmable radiation module to be in direct contact with the material;
positioning the build platform relative to the irradiation surface such that a layer of uncured material is defined between the build surface and the irradiation surface; and
irradiating the layer of uncured material with radiation, wherein irradiating comprises selectively activating the radiation emitting elements of the array of the programmable radiation module to polymerise the layer of uncured material by the radiation having a pattern generated by the selectively activated radiation emitting elements
